(19) United States
(12) Patent Application Publication
(10) Pub. No.: US 2006/0064367 A1
(43) Pub. Date: Mar. 23, 2006

(54) Systems and methods for insuring intellectual property holding companies

(76) Inventors: Robert J. Block, Chicago, IL (US); Andrew Carter, Glen Ellya, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/947,379

(22) Filed: Sep. 23, 2004

(51) Int. Cl. G06Q 40/00

(52) U.S. Cl. 705/35; 705/4

(57) ABSTRACT

A method is performed by an insurance transaction workstation for structuring an insurance transaction between an insured entity owning an intellectual property holding company (IPHC) and an insurer. The method includes receiving an insurance coverage request for protection against a loss based on a successful taxing authority challenge to tax benefits or value derived from the IPHC, calculating a probability of success of the taxing authority challenge, and identifying an intellectual property (IP) portfolio owned by the IPHC. The method further includes estimating a current value of IP assets in the identified IP portfolio and determining an insurance premium of an insurance policy based on the received insurance coverage, the calculated probability of success, and the current value of the IP assets.

### FIELD OF THE INVENTION

The present application relates generally to computer systems and methods for insurance transactions, and more particularly to systems and methods for managing and transferring, financial and operational risk for an intellectual property holding company (IPHC).

### BACKGROUND OF THE INVENTION

An insurance transaction typically involves obtaining protection to compensate the insured if a specified event occurs. Common examples include auto, home, health and life insurances. Each type of insurance typically provides compensation to the insured in the event of a predefined event, such as an accident or theft in the case of automobile insurance. In most cases, the insurance premium is determined based on the probability that the event will occur and the compensation amount that will need to be provided if the event occurs.

Insurance transactions related to intellectual property (IP) assets, however, are sometimes difficult to conduct because the transactions may be affected by a large variety of factors. Until recently, there has been no comprehensive and systematic methods for managing and transferring, financial and operational risk for IPHCs.

### SUMMARY OF THE INVENTION

In an aspect of the present invention, a method is performed by an insurance transaction workstation for structuring an insurance transaction between an insured entity owning an intellectual property holding company (IPHC) and an insurer. The method includes receiving an insurance coverage request for protection against a loss based on a successful taxing authority challenge to tax benefits or value derived from the IPHC, calculating a probability of success of the taxing authority challenge, and identifying an intellectual property (IP) portfolio owned by the IPHC. The method further includes estimating a current value of IP assets in the identified IP portfolio and determining an insurance premium of an insurance policy based on the received insurance coverage, the calculated probability of success, and the current value of the IP assets.

Consistent with another aspect of the present invention, a system is provided for structuring an insurance transaction between an insured entity owning an IPHC and an insurer. The system includes a central processing unit programmed to receive an insurance coverage request for protection against a loss based on a successful taxing authority challenge to tax benefits or value derived from the IPHC, to calculate a probability of success of the taxing authority challenge, to identify an intellectual property (IP) portfolio owned by the IPHC, to estimate a current value of IP assets in the identified IP portfolio, and to determine an insurance premium of an insurance policy based on the received insurance coverage, the probability of success, and the current value of the IP assets. The system also includes a memory to store program code executed by the central processing unit.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a pictorial illustration of an exemplary work environment incorporating certain embodiments of the present invention;

FIG. 2 is a functional block diagram of an exemplary insurance transaction workstation consistent with the present invention; and

FIG. 3 illustrates a flowchart diagram of an exemplary insurance transaction process performed by an insurance transaction workstation.

### DESCRIPTION OF THE EMBODIMENTS

In the following description, for the purposes of explanation, numerous specific details are set forth in order to provide a thorough understanding of the present invention. It will be evident to one skilled in the art, however, that the exemplary embodiments may be practiced without these specific details. In other instances, structures and device are shown in diagram form in order to facilitate description of the exemplary embodiments.

Reference will now be made in detail to embodiments of the present invention, examples of which are illustrated in the accompanying drawings. Wherever possible, the same reference numbers will be used throughout the drawings to refer to the same or like parts.

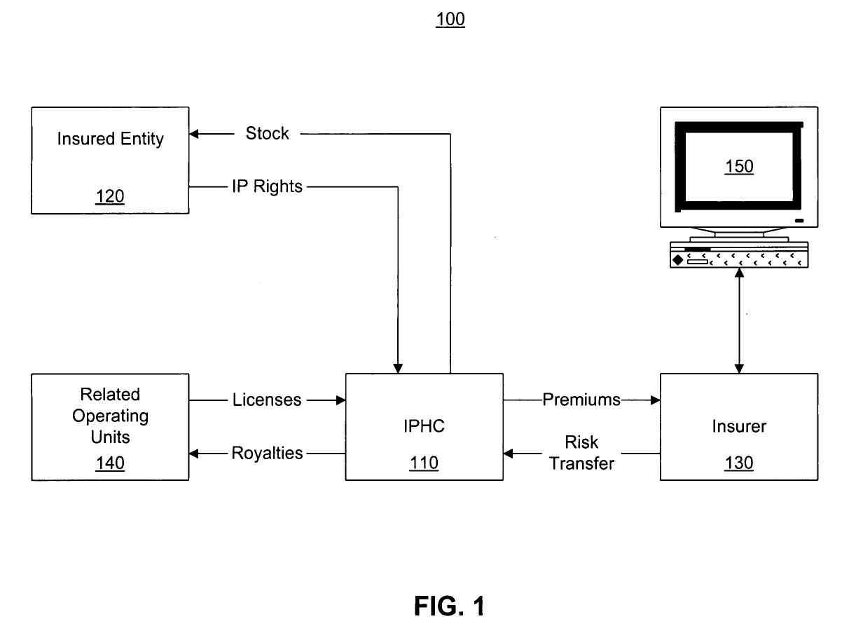

FIG. 1 illustrates an exemplary work environment for structuring an insurance transaction transferring risk in relationship to an intellectual property holding company (IPHC) transaction. As shown in FIG. 1, a work environment 100 includes an IPHC 110, an insured entity 120, an insurer 130, related operating units 140, and an insurance transaction workstation 150.

Insured entity 120 may be any type of entity that owns rights in one or more IP assets. For example, insured entity 120 may be a corporation, a partnership, an individual, etc.

Ownership of the one or more IP assets by insured entity 120 may be based on creation, for example where a person within insured entity 120 creates an invention and obtains a patent directed to the invention or creates an original work and obtains a copyright. Alternatively, ownership may be a result of an acquisition of an IP asset originally owned by another entity. Further, ownership may be based on an acquisition by licensing of an IP asset owned by another. Yet further, the ownership may be ownership in whole or in part. Ownership of an IP asset can include any type of ownership that confers the right to exercise one or more IP rights associated with the IP asset.

Examples of IP assets may include patents, copyrights, trade secrets, trademarks, etc. Patents entitle the owner to exclude others from practicing the invention covered by the claims in the patent. Another type of intellectual property is information described in writings and knowledge arising within a business which is: (a) not generally known by others; (b) retained in secret, and (c) disclosed to others only under an obligation of confidentiality (hereinafter referred to as “trade secrets” or “know how”). Copyrights are another form of IP that may be securitized. Copyrights provide authors with the right to control reproduction of their original intellectual creations, such as literary works, musical works, dramatic works, pictorial works, motion pictures, sound recordings and architectural works.

A characteristic of all such intellectual property assets may be the right to license, lease, or otherwise convey rights to others to use or otherwise practice the useful art, in whole or in part, embodied in such intellectual properties (hereinafter referred to as “licensing”). The licensing of these rights to a third party may be made in return for some type of compensation, such as royalty payments. A further characteristic of intellectual property assets may be the right to identify potential infringers of the intellectual property asset and to request or sue for payment of a reasonable royalty rate or other remuneration based on the infringing use.

IP rights can include any right associated with an IP asset. An IP right may be conferred by statute, case law, practice in the industry, inherent properties, etc. An IP right may further include the right to perform an action and/or prevent another party from performing an action. For example, patents may be characterized as entitling the owner to exclude others from importing, making, using, selling, or offering to sell the invention covered by the patent. Further, copyrights may be characterized as providing authors the right to control reproduction of their original intellectual creations, such as literary works, musical works, dramatic works, pictorial works, motion pictures, sound recordings and architectural works, along with the right to make derivative works.

Further, it is often possible to license IP rights arising from the same IP asset or group of IP assets to two or more entities simultaneously. For example, as stated above, a patent may generally include a right to exclude others from practicing the invention. Inherent in the right to exclude may be the right to license particular entities to practice the invention, usually in return for compensation, such as licensing fees. Further, different types of licenses may be granted such as an exclusive license, a non-exclusive license, an exclusive license within a defined field of use, etc. If a license to one entity is other than an exclusive license to all fields of use for the entire economic life of the underlying IP asset, residual rights in the IP asset may be created and may be licensed to other entities. Thus, a residual portion of an IP asset may include a right under the IP asset that is less than all of the rights afforded by the IP asset.

Therefore, insured entity 120 may not be fully utilizing the IP rights afforded under one or more IP assets. For example, where insured entity 120 is a vehicle manufacturer that owns a patent directed to a method of spray painting, the vehicle manufacture may only be utilizing the patented method of spray painting as applied to vehicles. Accordingly, the only portion of the IP rights that the vehicle manufacture needs to practice its trade is the right to spray paint vehicles under the patent, despite that the patented method may be useful for objects other than vehicles. In this situation, the unused portion of the IP rights is simply wasted in the sense that it may have economic value to others but is not being exploited.

This is the case when the patent rights owned by one party (e.g., insured entity 120) are broader than what it needs to practice its trade. In the example provided above, the spray painting method being used by the vehicle manufacturer to spray paint vehicles may be broad enough to cover and would also work well for spray painting houses. In this example, the portion of the IP rights not being used by the vehicle manufacture may be referred to as a residual portion. The residual portion may not be utilized by the vehicle manufacturer because the manufacturer may have no interest in preventing others from using this method to spray paint houses. The IP right residual portion may include numerous residual portions delineated by field of use, term of use, geographic location of use, etc.

Further, a company may own IP assets that are non-core IP assets. That is, the subject matter of the IP assets may not be aligned with the focus of the company's business strategy. In these situations, the company may not currently be using any of the IP rights associated with the non-core IP assets.

The residual portion of the IP rights or the IP rights associated with non-core IP assets, although not valuable to the insured entity 120 in its present business, may be valuable to another entity in a different business. To continue the example from above, a house painting entity may be interested in utilizing the residual portion of the spray painting IP asset. In particular, the house painting entity may desire to license one or more IP rights in the residual portion of the IP asset for painting houses. Further, there may be infringers of the residual portion of the IP asset. As such, it may be possible to obtain reasonable royalties based on the infringing use of residual rights by the infringers.

However, insured entity 120 may not possess resources or specialized required knowledge to capture a potential income that may be generated based on the residual portion of the IP rights or the non-core IP rights. For example, licensing revenue can only be generated if insured entity 120 is able to identify potential licensees. Identifying potential licensees may require in depth analysis of IP rights and markets where the IP rights may be of value. This type of analysis may require a diverse and specialized knowledge base.

According to an exemplary embodiment, insured entity 120 may desire to concentrate expertise in the licensing or monetization of intellectual property in a dedicated entity or IPHC managed by outside consultants or expert staff. Accordingly, insured entity 120 may transfer IP rights to IPHC 110 in return for stock in IPHC 110. System 100 may then allow other operating units 140 of entity 120 to obtain licenses from IPHC 110 in exchange for royalties.

At the same time, IPHC 110 may obtain value from the relevant intellectual property by entering into an active licensing program. Alternatively and conjunctively, IPHC 110 may obtain value from the relevant intellectual property by, for example, intellectual property collateralized borrowings or securitizations which may serve to lock in the borrowing power or imputed liquidity of the intellectual property value, reducing or hedging the risk that the intellectual property will be held invalid or otherwise encumbered.

When properly organized and operated, IPHC 110 may confertax benefits. Since insured entity 120 may transfer intellectual property to IPHC 110 and then pays royalties to IPHC 110 for rights to use the intellectual property in the course of its business. If insured entity 120 is domiciled in a high tax jurisdiction and IPHC 110 is domiciled in a low tax jurisdiction, the net effect may be to reduce income in the high tax jurisdiction through the payment of fully deductible royalties and increase income in the low tax jurisdiction through receipt of such royalties.

The future value of such tax reductions, discounted for the time value of money, may be referred to as having an ascertainable net present value (NPV). The NPV of future tax benefits for IPHC 110 may run into the millions of dollars and could conceivably run into the hundreds of millions, or billions of dollars for an appropriately sized corporation. Organizers of IPHC 110 obtain many other benefits from this method of doing business, including administrative and operational efficiencies. However, there may exist a risk of legal challenge by taxing authorities which may threaten NPV or operation of IPHC 110.

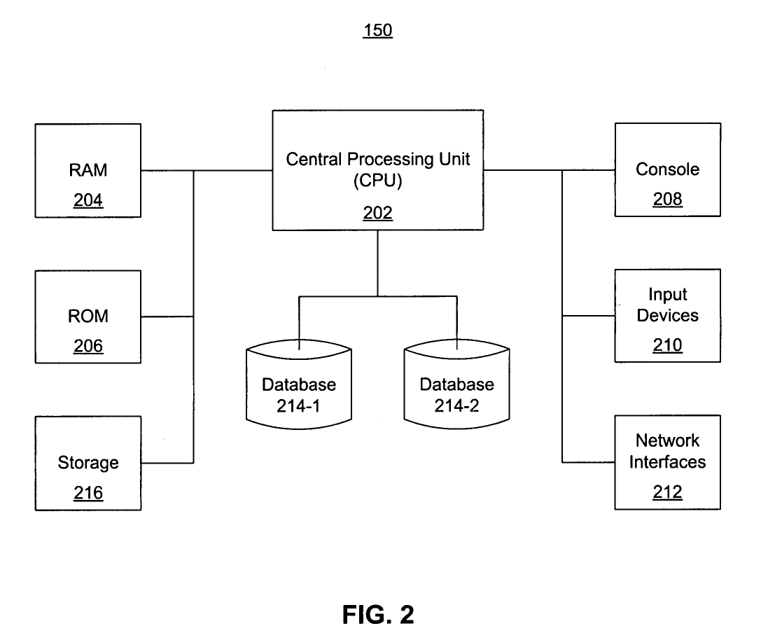

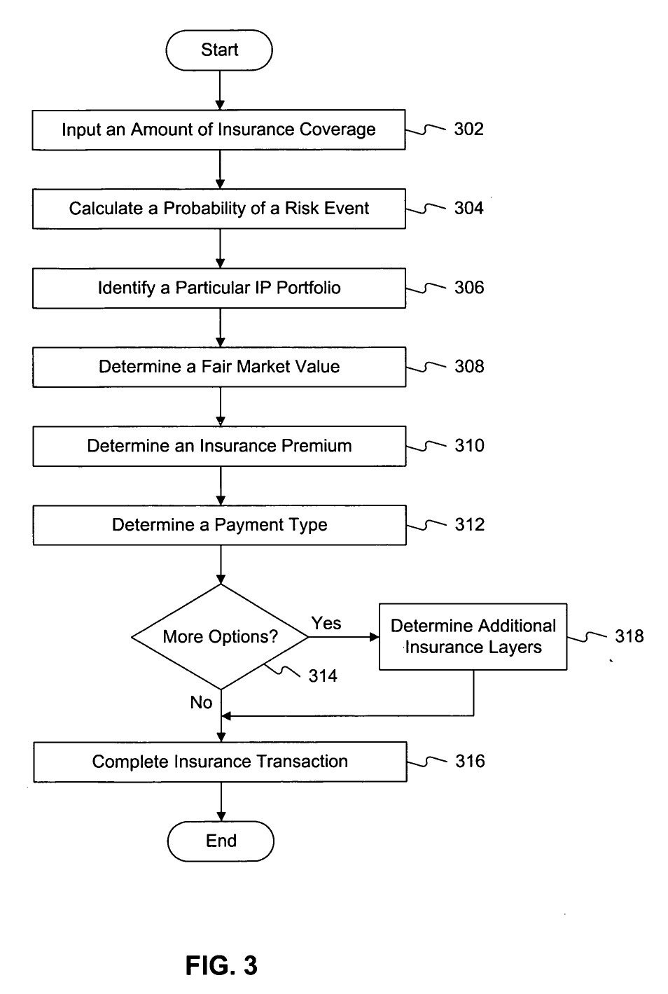

Further, insured entity 120 may seek insurance protection against legal challenge to IPHC 110 operations and NPV. Insurer 130 may provide the insurance protection to insured entity 120 to exchange insurance premiums paid by IPHC 110 or insured entity 120. When conducting an insurance transaction to provide the insurance protection, insurer 130 may use insurance transaction workstation 150 to structure the insurance transaction to protect against a loss related to a legal challenge to IPHC 110 operations by identifying IPHC 110 operational structures and protocols calculated to maximize non-tax benefits, and to blend insurance protection and IPHC 110 operational improvements to optimize underwriting pricing and efficiency. The details of insurance transaction workstation 150 is described below corresponding to FIG. 2 and the details of the insurance transaction itself is described corresponding to FIG. 3.

As shown in FIG. 2, insurance transaction workstation 150 may include a central processing unit (CPU) 202, a random access memory (RAM) 204, a read-only memory (ROM) 206, a storage 216, a console 208, input devices 210, network interfaces 212, and databases 214-1 and 214-2. It is understood that the type and number of listed devices are exemplary only and not intended to be limiting, the number of listed devices may be varied and other devices may be added without departing the principle and scope of the present invention.

CPU 202 may execute sequences of computer program instructions, more specifically, sequences of computer program instructions that cause CPU 202 to perform various steps of insurance transactions consistent with the present invention. The computer program instructions may be loaded into RAM 204 for execution by CPU 202 from a read-only memory (ROM). Storage 216 may be any mass storage provided to store any type of information CUP 202 may need to perform operations. Storage 216 may be one or more hard disk devices, optical disk devices, or other storage devices to provide storage space for security gateway.

Console 208 may provide a graphic user interface (GUI) to display information to users of insurance transaction workstation 150. Console 208 may be any type of computer display devices or computer monitors. Input devices 210 may be provided for the users to input information into insurance transaction workstation 150. Input devices 210 may include a keyboard, a mouse, or other optical or wireless computer input devices. Further, network interfaces 212 may provide communication connections such that insurance transaction workstation 150 may be accessed remotely through computer networks.

Databases 214-1 and 214-2 may contain customer data and any information related to insurance transaction on IP assets. Databases 214-1 and 214-2 may also include analyzing tools for analyze the information in the databases. CPU 202 may use databases 214-1 and 214-2 to estimate NPV, calculate risk probability, determine premiums, or analyze business operations, etc.

As explained above, insurance transaction workstation 150, more specifically CPU 202, may perform an insurance transaction upon requested by insurer 130. FIG. 3 illustrates a flowchart of an exemplary insurance transaction process consistent with the present invention. As shown in FIG. 3, at the beginning of the transaction process, an amount of coverage may be inputted to CPU 202 (step 302). The amount of coverage may be previously determined based on typical award amounts for the industry, the technology, known exposures to risks, etc. For example, insured entity 120 may wish to obtain $100 million in insurance based on tax awards that were issued against several competitors in the same industry in a recent period.

After received the amount of coverage, CPU 202 may calculate a probability that a claim against the insurance amount will occur (i.e., a successful taxing authority challenge to tax benefits or value derived from IPHC 110) (step 304). The probability that a claim will occur may be based on information in databases 214-1 and 214-2 such as previously acquired expert knowledge of the field and/or other considerations (e.g., actuarial tables, statistics, etc.).

Further, CPU 202 may structure the insurance transaction such that insurer 130 employs intellectual property attorneys and experts to audit insured entity 120's IPHC protocols and procedures with the expert's report and recommendations impacting the insurance policy premium. To structure the insurance transaction, CPU 202 may first proceed to identify a particular IP portfolio (step 306). A particular IP portfolio may identified based on an IPHC owner's IPHC practices and protocols as well as the value and inventory or relevant IP. The IPHC owner may pay an underwriting fee and execute an appropriate non-disclosure agreement with the prospective insurer. The IPHC owner would agree to disclose information relating to its IPHC practices and protocols as well as the value and inventory of relevant IP.

Once a particular IP portfolio is identified, CPU 202 may determine its current fair market value (step 308). There are a number of different approaches to determining fair market value of IP assets, a method of combining an estimate of the value of an IP asset with an assessment of the impact on the value of the selling business of utilizing that IP asset may be provided in certain embodiments of the present invention.

This method comprises receiving information related to at least one IP asset, calculating a value of the at least one IP asset using a first valuation algorithm, selecting a second valuation algorithm having a plurality of inputs, inputting the value of at least one IP asset into the second valuation algorithm, inputting at least one additional piece of information required by the second valuation algorithm, and calculating the change in value to the owner of the IP asset using the second valuation algorithm. The method may further comprise inputting an identifier indicative of a utility of the IP asset by selecting from a list including such options as: “new product category,” “improvement on an existing product,” “a new process,” “an improvement on an existing process,” and “regulatory compliance.” The method may further comprise selecting a first valuation algorithm from a plurality of valuation algorithms by selecting a first valuation algorithm particular to the type of utility associated with the IP asset. The method may further comprise receiving information on the financial characteristics of the owner not directly related to the IP asset.

Typical information used for the valuation method of this embodiment includes, but is not limited to: current and projected future revenues and costs of the goods covered by the IP asset, cost savings attributable to an invention covered by an IP asset, the book value of the business activities associated with the IP asset, and ongoing expenditures for marketing, research and development. As will be appreciated, it can be difficult to calculate a value for an IP asset that is not associated with any current or ongoing revenues or costs.

The particular valuation algorithm used will determine what information must be obtained regarding the IP asset and entered for the valuation to be completed. For example, when making a valuation for a patent covering an environmental control invention that permits a business to continue operation under regulatory requirements, the evaluation should take into consideration the ongoing revenue generated by the continuation of the business. In addition to financial information, information such as the remaining life of the patent may be used by the first valuation algorithm.

Once the appropriate first valuation algorithm has been determined for each IP asset within a portfolio, the current value of the portfolio is determined using the appropriate algorithms.

Once the current value of the particular IP portfolio is determined, CPU 202 may determine an insurance policy premium amount based on the amount of insurance coverage, the probability that a claim against the insurance amount will occur and the current value of the particular IP portfolio using a predetermined algorithm(step 310). The current value of the particular IP portfolio may also be relevant to determining the reasonableness of IPHC royalties and the sophistication of IPHC asset management or borrowing programs. The insurance premium may also include different levels for insured entity 120 to select in order to protect a net present value of future tax benefits represented to insured entity 120 by IPHC operations.

Once the insurance policy premium is determined, CPU 202 may further determine type of payment for the insurance policy premium (step 312). CPU 202 may perform certain business intelligence algorithms to decide a desired payment type or require insurer 130 to input a desired payment type. The type of payment may include, but is not limited to, cash, assignment of IPHC stock, and a mixture of cash and assignment of IPHC stock.

Further, CPU 202 may decide, whether automatically or based on a request by insurer 130, whether other options should be considered (step 314). If no other options is to be considered (step 314; no), CPU 202 may complete the insurance transaction process (step 316). On the other hand, if other options are desirable (step 314; yes), CPU 202 may further analyze the insurance transaction, or obtain information from insurer 130, to determine additional layers of insurance according to various methods and structures (step 318). For example, the insurance transaction may include one or more insurance coverage amounts configured to be paid after the insurance coverage described above has been exhausted. The additional insurance coverage layers may include standard insurance premium payment structures. The additional insurance coverage may further include any type of insurance coverage structure, such as a captive insurance structure wherein the insuring entity is owned by insured entity 120.

After consideration of the additional insurance coverage, CPU 202 may perform step 316 to complete the insurance transaction process and generate an insurance policy. The insurance policy, consistent with the present invention, may also be structured in such a way to minimize moral hazard by setting appropriate deductibles or attachment point levels and by offering insurer 130 a right to associate in the insured entity 120's defense and to participate in settlement negotiations. Further, the insurance policy may also include endorsements covering shareholder claims arising from IPHC 110's tax benefits or operations against management liability or directors and officers of insured entity 120.

Since the particular IP portfolio groups patent rights in IPHC 110 with insured NPV, economies of scale in the exercise of patent rights may be achieved. For example, IPHC 110 is specifically configured for the exercise of patent rights. Accordingly, IPHC 110 may have greater resources and/or more experience at obtaining income based on the residual rights. Such income may be obtained by identifying potential licensees, pursuing litigation against infringers, etc. It may be economical for insured entity 120 to make the investment in personnel and resources in IPHC 110 only if NPV value is realized over time. By locking in such value through insurer entity 130, insured entity 120 may have the confidence to make and pursue an appropriate level of investment in IPHC management which simultaneously reduces the risk of a successful challenge by tax authorities. By protecting insured entity 120's investment, insurer 130 may enable insured entity 120 to invest with the confidence and at the level necessary to withstand tax authority challenges by pointing to meaningful IPHC management activity.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electronic method for structuring an insurance transaction between an insured entity owning an intellectual property holding company (IPHC) and an insurer, comprising:
receiving an insurance coverage request for protection against a loss based on a successful taxing authority challenge to tax benefits or value derived from the IPHC;
calculating a probability of success of the taxing authority challenge;
identifying an intellectual property (IP) portfolio owned by the IPHC;
estimating a current value of IP assets in the identified IP portfolio; and
determining an insurance premium of an insurance policy based on the received insurance coverage request, the calculated probability of success, and the current value of the IP assets.

2. The method according to claim 1, further comprising:
determining a payment type of the premium, wherein the payment type is one of at least cash, assignment of stock, and mixture of cash and assignment of stock.

3. The method according to claim 1, further comprising:
considering additional layers of insurance coverage.

4. The method according to claim 1, further comprising:
considering additional levels of premium for the insured entity to select to protect a net present value of future tax benefits represented to the insured entity by its IPHC operations.

5. The method according to claim 1, further comprising:
structuring the insurance policy in such a way as to minimize moral hazard by setting appropriate deductibles or attachment point levels and by offering the insurer a right to associate in the insured entity's defense and to participate in the insured entity's settlement negotiations.

6. The method according to claim 1, further comprising:
adding endorsements on the Insurance policy to cover shareholder claims arising from the insured entity's IPHC tax benefits or operations against management liability or directors and officers of the insured entity.

7. The method according to claim 1, wherein identifying further comprises:
collecting information relating to the insured entity's IPHC practices, IPHC protocols, and value and inventory of relevant IP assets from IP attorneys and experts employed by the insurer to audit the IPHC; and
collecting relevant information disclosed by the insured entity after signing a non-disclosure agreement with the insurer; and
identifying a group of IP assets within the IP portfolio.

8. The method according to claim 1, wherein the current value is a net present value of future tax benefits of the IPHC.

9. A system for structuring an insurance transaction between an insured entity owning an IPHC and an insurer, comprising:
a central processing unit programmed to:
receive an insurance coverage request for protection against a loss based on a successful taxing authority challenge to tax benefits or value derived from the IPHC,
calculate a probability of success of the taxing authority challenge,
identify an intellectual property (IP) portfolio owned by the IPHC,
estimate a current value of IP assets in the identified IP portfolio, and
determine an insurance premium of an insurance policy based on the
received insurance coverage request, the calculated probability of success, and the current value of the IP assets; and
a memory to store program code executed by the central processing unit.

10. The system according to claim 9, further comprising:
one or more databases to store and analyze business information and insurance transaction operations.

11. The system according to claim 10, further comprising:
a storage unit to store information used by the central processing unit.

12. A computer-readable medium for use on an insurance transaction workstation for structuring an insurance transaction between an insured entity owning an IPHC and an insurer, the computer-readable medium having computer-executable instructions for performing a method comprising:
receiving an insurance coverage request for protection against a loss based on a successful taxing authority challenge to tax benefits or value derived from the IPHC;
calculating a probability of success of the taxing authority challenge;
identifying an intellectual property (IP) portfolio owned by the IPHC;
estimating a current value of IP assets in the identified IP portfolio; and
determining an insurance premium of an insurance policy based on the received insurance coverage request, the calculated probability of success, and the current value of the IP assets.

13. The computer-readable medium according to claim 12, wherein the method further comprises:
considering additional layers of insurance coverage.

14. The computer-readable medium according to claim 12, wherein the method further comprises:
considering additional levels of premium for the insured entity to select to protect a net present value of future tax benefits represented to the insured entity by its IPHC operations.

15. The computer-readable medium according to claim 12, wherein the method further comprises:
structuring the insurance policy in such a way as to minimize moral hazard by setting appropriate deductibles or attachment point levels and by offering the insurer a right to associate in the insured entity's defense and to participate in the insured entity's settlement negotiations.

16. The computer-readable medium according to claim 12, wherein the method further comprises:
adding endorsements on the insurance policy to cover shareholder claims arising from the insured entity's IPHC tax benefits or operations against management liability or directors and officers of the insured entity.

17. The computer-readable medium according to claim 12, wherein the step of identifying of the method further comprises:
collecting information relating to the insured entity's IPHC practices, IPHC protocols, and value and inventory of relevant IP assets from IP attorneys and experts employed by the insurer to audit the IPHC; and
identifying a group of IP assets within the IP portfolio.
